(19) United States
(12) Patent Application Publication
(10) Pub. No.: US 2026/0067140 A1
(43) Pub. Date: Mar. 5, 2026

(54) SEMANTIC COMMUNICATION METHOD AND RELATED DEVICE

(71) Applicant: Beijing University of Posts and Telecommunications, Beijing (CN)

(72) Inventors: Wenjun XU, Beijing (CN); Lan LIN, Beijing (CN); Ping ZHANG, Beijing (CN); Fengyu WANG, Beijing (CN); Yimeng ZHANG, Beijing (CN)

(73) Assignee: Beijing University of Posts and Telecommunications, Beijing (CN)

(21) Appl. No.: 19/380,921

(22) Filed: Nov. 5, 2025

Related U.S. Application Data
(63) Continuation of application No. PCT/CN2024/092401, filed on May 10, 2024.

(30) Foreign Application Priority Data
Oct. 26, 2023 (CN) 202311402768.7

(51) Int. Cl. H04L 27/26

(52) U.S. Cl. CPC H04L 27/2601

(57) ABSTRACT

In a semantic communication method, input information from a transmitter may be input into a pre-trained semantic encoder to obtain semantic signals. Then, the semantic signals may be transmitted to a first channel to obtain a third semantic signal. Moreover, a transmitter-side signal processing may be performed on the semantic signals to obtain processed semantic signals. Then the processed semantic signals may be transmitted to a second channel to obtain fourth semantic signals. Further, a receiver-side signal processing may be performed on the fourth semantic signals obtain fifth semantic signals. Finally, the fifth semantic signals may be optimized and then be input into a pre-trained semantic decoder for semantic decoding to obtain first decoded information and second decoded information.

### CROSS-REFERENCE TO RELATED APPLICATIONS

This application is a continuation of International Application No. PCT/CN2024/092401, filed on May 1, 2024, which claims priority to Chinese Patent Application No. 202311402768.7, filed on Oct. 26, 2023. The disclosures of the above-mentioned applications are hereby incorporated by reference in their entireties.

### TECHNICAL FIELD

The present disclosure relates to communication technologies, and in particularly, to a semantic communication method and related devices.

### BACKGROUND

Semantic communication is a novel communication architecture that integrates semantics and user needs for information into a communication process, which improves the transmission efficiency significantly by exploring semantic information. Unlike traditional communication methods, the semantic communications do not focus on the correctness of bit transmissions but prioritizes of contents being conveyed, ensuring a receiver understands an intended meaning of a transmitter correctly and reducing uncertainty. Instead of pursuing fidelity to raw data or signals, it extracts information at the semantic level from the source, achieving a more concise representation with the goal of “preserving meaning,” thereby drastically reducing a transmission bandwidth required and improving an end-to-end communication efficiency.

However, in existing technologies, power allocation and performance analysis for user semantic communication have not been addressed. Additionally, semantic encoders/decoders exhibit limitations in channel-type dependence and poor generalization in applications, both of which degrade the quality of semantic communications.

### SUMMARY

In view of the above, examples of the present disclosure provide a semantic communication method and related devices to address the problems of the existing technologies.

Examples of the present disclosure provide a semantic communication method, which may include: obtaining first input information and second input information from a transmitter; inputting the first input information into a pre-trained semantic encoder for extracting semantic features of the first input information to obtain first semantic signals; inputting the second input information into the pre-trained semantic encoder for extracting semantic features of the second input information to obtain second semantic signals; transmitting the first semantic signals and the second semantic signals to a first channel which performs a first signal superposition to obtain third semantic signals; performing a transmitter-side signal processing on the first semantic signals and the second semantic signals based on pre-determined channel coefficients of a second channel, to obtain first processed semantic signals and second processed semantic signals; transmitting the first processed semantic signals and the second processed semantic signals to the second channel which performs a second signal superposition to obtain fourth semantic signals; performing a receiver-side signal processing on the fourth semantic signals based on the channel coefficients to obtain fifth semantic signals; optimizing the fifth semantic signals with an objective of minimizing differences between the third semantic signals and the fifth semantic signals to obtain optimized fifth semantic signals; inputting the optimized fifth semantic signals into a pre-trained semantic decoder for semantic decoding to obtain first decoded information and second decoded information; where, the first decoded information corresponds semantically to the first input information, and the second decoded information corresponds semantically to the second input information.

Based on the same inventive concept, the present disclosure further provides an electronic device comprising a memory, a processor, and a computer program stored on the memory and executable by the processor, wherein the processor executes the computer program to implement the method described above.

Based on the same inventive concept, the present disclosure further provides a non-transitory computer-readable storage medium storing computer instructions, wherein the computer instructions are used to cause a computer to execute the method described above.

It can be seen that the semantic communication method and related devices disclosed combines semantic features with channel gains, aiming to minimize the differences between original semantic signals and reconstructed semantic signals by optimizing the transmitter-side signal processing function and the receiver-side signal processing function. It may address technical challenges of adaptively adjusting semantic signals based on channel gains of different subcarriers, facilitating transmissions of extracted semantic features over multi-subcarriers with varying channel gains. Additionally, it may resolve technical issues of transferring encoders/decoders trained in additive white Gaussian noise (AWGN) channels to other fading channels, eliminating drawbacks of requiring separate encoder/decoder training for channels with different statistical characteristics or types. This solution may ensure the quality of non-orthogonal multi-user semantic communications when original encoders/decoders are applied to fading channels. Moreover, a communication efficiency may be improved.

### BRIEF DESCRIPTION OF THE DRAWINGS

To illustrate technical solutions of the present disclosure or the prior art more clearly, drawings used in examples or the prior art will be briefly introduced. Obviously, the drawings in the following description are only some examples of the present disclosure. For those of ordinary skill in the art, other drawings may be obtained based on these drawings without creative effort.

FIG. 1 is a schematic diagram illustrating a structure of a channel-transferable Non-Orthogonal Multiple Access (NOMA) semantic communication system according to examples of the present disclosure.

FIG. 2 is a schematic flowchart of a channel-transferable semantic communication method according to examples of the present disclosure.

FIG. 3 is a schematic flowchart of the channel-transferable semantic communication method applied to a NOMA system according to examples of the present disclosure.

FIG. 4 is an element expansion table of complex matrix variables according to examples of the present disclosure.

FIG. 5 is a schematic diagram illustrating a structure of a channel-transferable semantic communication device applied to a NOMA system according to examples of the present disclosure.

FIG. 6 is a schematic diagram illustrating a hardware structure of an electronic device according to examples of the present disclosure.

### DETAILED DESCRIPTION OF THE EMBODIMENTS

To make the objectives, technical solutions, and advantages of the present disclosure clearer, the following further describes the present disclosure in detail with reference to specific examples and accompanying drawings.

It should be noted that, unless otherwise defined, technical terms or scientific terms used in the examples of the present disclosure shall have the ordinary meanings understood by persons skilled in the art. The terms “first”, “second”, and similar terms used in the examples of the present disclosure do not denote any order, quantity, or importance, but are merely used to distinguish different components. The terms “comprising” or “including” and similar terms mean that elements or items preceding the term encompass elements or items listed after the term and their equivalents, but do not exclude other elements or items. The terms “connected” or “coupled” and similar terms are not limited to physical or mechanical connections, but may include electrical connections, whether direct or indirect. Terms such as “upper”, “lower”, “left”, and “right” are used only to indicate relative positional relationships. When the absolute position of the described object changes, the relative positional relationship may also change accordingly.

As described in the background, autoencoder models in deep learning are unsupervised neural network models comprising an encoder and a decoder. They can learn latent features of input data and reconstruct an original input using these learned features, serving as a crucial tool for joint source-channel coding implementation in communication fields. Autoencoders enable a nonlinear dimensionality reduction for features, extracting more effective new characteristics. They play a pivotal role in semantic communication systems by performing key functions of extracting and reconstructing user semantic information.

Orthogonal Frequency Division Multiplexing (OFDM) is a multi-subcarrier modulation technology that achieves parallel transmissions of high-speed serial data. The core process involves dividing a frequency band into multiple orthogonal subcarriers that do not overlap spectrally, thereby reducing interferences. OFDM operates by transforming frequency-domain signals into time-domain signals via inverse Fourier transform at the transmitter, appending cyclic prefixes for transmissions, while the receiver removes these prefixes, converts the signals back to the frequency domain using Fourier transform, and demodulates original signals.

Non-Orthogonal Multiple Access (NOMA) enables resource multiplexing by allocating varying power levels to multiple users sharing a same time-frequency resource. Traditional NOMA technology employs non-orthogonal transmission with differential power allocations at the transmitter, deliberately introducing interferences, which is subsequently canceled via successive interference cancellation (SIC) receivers. Each subcarrier and time-slot symbol supports multiple users instead of one, creating multiple access interference (MAI). To mitigate this, NOMA uses SIC techniques for interference detection and elimination.

During implementations of this application, the applicant identified some limitations in existing researches. While prior studies addressed power allocations for traditional NOMA based on Shannon capacity to balance user capacities and outage probabilities, they neglected semantic communication scenarios. Existing NOMA-based semantic communication solutions for image transmission failed to leverage channel information. Some researches combined autoencoders with OFDM for adaptive wireless image transmission, but were limited to specific multipath fading channels, lacking generalization across diverse fading conditions. When channel types or parameter distributions changed, pre-trained autoencoder models became ineffective, degrading the quality of semantic communications.

To solve the above mentioned problems, examples of the present disclosure provide a semantic communication method. In this method, first input information and second input information from a transmitter may be obtained at first. Then, the first input information may be input into a pre-trained semantic encoder for extracting semantic features of the first input information to obtain first semantic signals and the second input information may also be input into the pre-trained semantic encoder for extracting semantic features of the second input information to obtain second semantic signals. Later, the first semantic signals and the second semantic signals may be transmitted to a first channel which performs a first signal superposition to obtain third semantic signals.

Moreover, a transmitter-side signal processing may be performed on the first semantic signals and the second semantic signals based on pre-determined channel coefficients of a second channel to obtain first processed semantic signals and second processed semantic signals. The first processed semantic signals and the second processed semantic signals may be transmitted to the second channel which performs a second signal superposition to obtain fourth semantic signals. Then, a receiver-side signal processing may be performed on the fourth semantic signals based on the channel coefficients to obtain fifth semantic signals. Further, the fifth semantic signals may be optimized with an objective of minimizing differences between the third semantic signals and the fifth semantic signals to obtain optimized fifth semantic signals. Finally, the optimized fifth semantic signals may be input into a pre-trained semantic decoder for semantic decoding to obtain first decoded information and second decoded information. Here, the first decoded information may correspond semantically to the first input information, and the second decoded information may correspond semantically to the second input information.

It can be seen that the semantic communication method and related devices disclosed combines semantic features with channel gains, aiming to minimize the differences between original semantic signals and reconstructed semantic signals by optimizing the transmitter-side signal processing function and the receiver-side signal processing function. It may address technical challenges of adaptively adjusting semantic signals based on channel gains of different subcarriers, facilitating transmissions of extracted semantic features over multi-subcarriers with varying channel gains. Additionally, it may resolve technical issues of transferring encoders/decoders trained in additive white Gaussian noise (AWGN) channels to other fading channels, eliminating drawbacks of requiring separate encoder/decoder training for channels with different statistical characteristics or types. This solution may ensure the quality of non-orthogonal multi-user semantic communications when original encoders/decoders are applied to fading channels. Moreover, a communication efficiency may be improved.

The technical solutions of the present disclosure would be described in details with examples and accompany drawings.

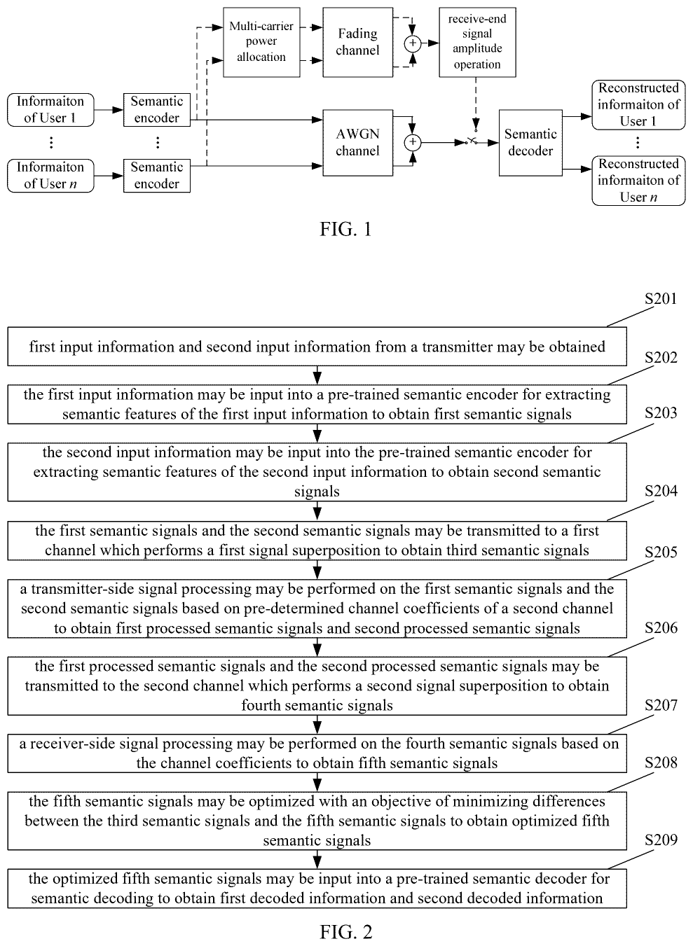

FIG. 1 is a schematic diagram illustrating a structure of a channel-transferable NOMA semantic communication system according to examples of the present disclosure.

Referring to FIG. 1, in an uplink NOMA transmission system where multiple users transmit information to the base station, with each subcarrier carrying semantic information from multiple users simultaneously. In this system, each transmitter of each user may be equipped with a semantic encoder, while each receiving base station may deploy a semantic decoder. For the channel-transferable NOMA semantic communication system, the NOMA semantic encoder-decoder is trained under AWGN channels and tested across other fading channels (e.g., Rician fading, or Rayleigh fading). By optimizing the power allocations of semantic transmission signals and the receive signal processing, the quality of end-to-end semantic communications may be ensured, achieving a channel transferability from AWGN channels to multi-subcarrier fading channels in the NOMA semantic communication system.

FIG. 2 is a schematic flowchart of a channel-transferable semantic communication method according to examples of the present disclosure. As shown in FIG. 2, the channel-transferable semantic communication method may include the following steps.

In block S201, first input information and second input information from a transmitter may be obtained.

In block S202, the first input information may be input into a pre-trained semantic encoder for extracting semantic features of the first input information to obtain first semantic signal.

In block S203, the second input information may be input into the pre-trained semantic encoder for extracting semantic features of the second input information to obtain second semantic signals.

In some examples of the present disclosure, the pre-trained semantic encoder in block S202 and in block S203 may refer to a same pre-trained semantic encoder. However, for the sake of descriptive convenience the pre-trained semantic encoder in block S202 may be called as a first pre-trained semantic encoder and the pre-trained semantic encoder in block S203 may be called as a second pre-trained semantic encoder.

In some implementations, it is assumed that there are N users in the semantic communication system, denoted as [symbol] ={1, 2, . . . , n, . . . , N}, which extract semantic features from the input messages Mₙ at the transmitter side through their respective semantic encoders θ_{E}_{ₙ}.

In some examples of the present disclosure, it may assume that there are two users, corresponding to two semantic encoders. The input information of the two users is the first input information and the second input information, respectively. The corresponding pre-trained semantic encoders can extract the semantic features of the first input information and the second input information.

In an example, the semantic features of the first input information may be converted into a first complex number corresponding to a subcarrier; and the first complex number may be normalized according to a predefined power constraint to obtain the first semantic signals.

In an example, the semantic features of the second input information may be converted into a second complex number corresponding to a subcarrier; and the second complex number may be normalized according to a predefined power constraint to obtain the second semantic signals.

Specifically, to facilitate system transmissions, the semantic features may be represented as complex numbers corresponding to the subcarriers Xₙ=θ_{E}_{ₙ}(Mₙ)∈ [symbol] ^{L×K}, where, K represents the number of subcarriers, L represents the number of OFDM-NOMA symbols, and each symbol subcarriers K semantic features for transmissions. Xₙ=θ_{E}_{ₙ}(Mₙ)∈ [symbol] ^{L×K} denotes the semantic feature of user n at the k-th subcarrier of the l-th OFDM-NOMA symbol. The semantic features of each user's OFDM-NOMA symbol across all subcarriers are represented as X_{n,l}, subject to the average power Pₙ constraint of each user. The normalized semantic transmission signal T_{n,l} is expressed as:

$${T}_{n , l} = \frac{\sqrt{{P}_{n}}}{{‖ {x}_{n , l} ‖}_{2}} {X}_{n , l} ∈ {ℂ}^{K} .$$

In block S204, the first semantic signals and the second semantic signals may be transmitted to a first channel which performs a first signal superposition to obtain third semantic signals.

Specifically, after passing through the AWGN channel, the semantic signals are superimposed, which can be represented as:

$$Y = {\sum }_{n = 1}^{N} {T}_{n} + W ∈ {ℂ}^{L \times K} .$$

Where, Tₙ={T_{n,1}, . . . , T_{n,L}}; W∈ [symbol] ^{L×K} represents a noise matrix; elements w_{l,k} of the noise matrix are complex Gaussian noise terms with independent and identical distributions and with a variance of δₑ², i.e.

$${w}_{l , k} ∼ 𝒞𝒩 ( 0 , {δ}_{e}^{2} ) .$$

It should be noted that the number of semantic encoders at the transmitter is not limited to two. It can be flexibly configured based on the number of users and actual subcarrier requirements.

As an example, the semantic encoder and the semantic decoder may be constructed by the following method. At first, historical input messages of the transmitter may be obtained as a training set. Then, semantic features of the training set may be extracted through an initial semantic encoder to obtain first training signals. Later, the first training signals may be transmitted through the first channel to the receiver. Then, the first training signals may be parsed through an initial semantic decoder to obtain second training signals. Moreover, a loss function based on the first training signals and the second training signals may be constructed. Finally, the initial semantic encoder and the initial semantic decoder may be trained by minimizing the loss function to obtain the pre-trained semantic encoder and the pre-trained semantic decoder.

In practical implementations, the semantic decoder φ_{D} deployed at the base station (the receiver) may perform an information reconstruction from received superimposed signals Y to obtain reconstructed information, which can be denoted as \hat{M}=φ_{D}(Y)∈ [symbol] ^{L×K×N}, where, \hat{M}=[\hat{M}₁, \hat{M}₂, . . . , \hat{M}_{N}] represents a matrix combining the reconstructed information of all users. The loss function between the reconstructed information and original information may be represented as:

$$ℒ ( {θ}_{{E}_{1}} , ⋯ , {θ}_{{E}_{n}} , {ϕ}_{D} ) = {\sum }_{n = 1}^{N} {‖ {\hat{M}}_{n} - {M}_{n} ‖}_{2}^{2} .$$

By minimizing the loss function, the NOMA semantic encoder-decoder system may be trained, and the trained encoder-decoder may be denoted as

$${Γ}^{*} ( {θ}_{{E}_{1}}^{*} , ⋯ , {θ}_{{E}_{n}}^{*} , {ϕ}_{D}^{*} ) .$$

In block S205, a transmitter-side signal processing may be performed on the first semantic signals and the second semantic signals based on pre-determined channel coefficients of a second channel to obtain first processed semantic signals and second processed semantic signals.

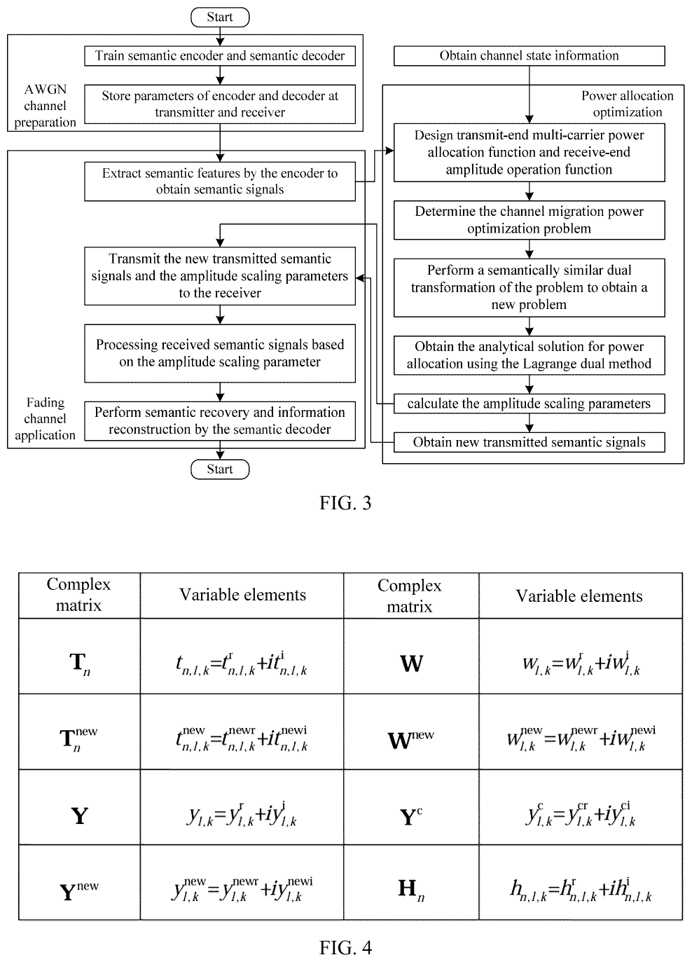

FIG. 3 is a schematic flowchart of the channel-transferable semantic communication method applied to a NOMA system according to examples of the present disclosure.

In practical implementations, the encoder-decoder trained under AWGN channels cannot yet be directly applied to multi-subcarrier fading channels. In the NOMA semantic communication system proposed in this application, a method is provided to optimize multi-subcarrier power allocations based on channel gains under fading channels. In this method, computational processing on the semantic signals at both the transmitter and receiver may be performed, therefore, the encoder-decoder trained can be applicable to fading channels.

In some examples of the present disclosure, a transmitter-side signal processing function may be constructed based on the pre-determined channel coefficients of the second channel at first. Then, first processed semantic signals may be obtained based on the first semantic signals and the transmitter-side signal processing function; and second processed semantic signals may be obtained based on the second semantic signals and the transmitter-side signal processing function.

Specifically, when the type of the channel changes, the fixed-parameter semantic encoder-decoder Γ* will continue to generate semantic signals T. However, these signals cannot be directly used as transmission signals, as changes in the channel would lead to a degradation in communication quality. To avoid this issue, the semantic signals T must undergo a signal processing based on the channel coefficients of the channel with a type of C_{b}, yielding new signals as the transmission signals. Specifically, the first semantic signals and the second semantic signals, after being processed by a power allocation function ƒₜ(⋅), optimized semantic signals may be produced. The optimized semantic signals may be denoted as:

$${T}_{n}^{new} = {f}_{t} ( {T}_{n} , H ) .$$

Where,

$${T}_{n}^{new} = \{ {T}_{n , 1}^{new} , ⋯ , {T}_{n , L}^{new} \}$$

may be used to represent the first processed semantic signals and the second processed semantic signals; H=[H₁, H₂, . . . , H_{N}]∈ [symbol] ^{L×K×N} represents a channel fading coefficient matrix.

In block S206, the first processed semantic signals and the second processed semantic signals may be transmitted to the second channel which performs a second signal superposition to obtain fourth semantic signals.

In block S207, a receiver-side signal processing may be performed on the fourth semantic signals based on the channel coefficients to obtain fifth semantic signals.

In an example of the present disclosure, the superimposed signal after the first processed semantic signals and the second processed semantic signals pass through the fading channel may be expressed as:

$${Y}^{c} = {\sum }_{n = 1}^{N} {H}_{n} {T}_{n}^{new} + {W}^{new} .$$

Then, after passing through the channel with the type of C_{b}, the received signals Y^{c} may be obtained. Moreover, a receive signal processing may be performed on it to generate new signals as inputs to the decoder φ_{D}*, which may be expressed as: Y^{new}=ƒᵣ(Y^{c}, C_{b}).

In some examples of the present disclosure, in this block 207, a receiver-side signal processing function may be constructed based on the pre-determined channel coefficients of the second channel at first. Further, the fifth semantic signals may be obtained based on the fourth semantic signals and the receiver-side signal processing function.

Specifically, taking the NOMA system as an example, a transmit-end multi-subcarrier power allocation function ƒₜ(⋅) and a receive-end signal amplitude operation function ƒᵣ(⋅) need to be designed.

In this example, the transmit-end multi-subcarrier power allocation function ƒₜ(⋅) may be expressed as:

$${t}_{n , l , k}^{new} = {t}_{n , l , k}^{r} {P}_{n , l , k}^{r} + {it}_{n , l , k}^{i} {P}_{n , l , k}^{i} ∈ {T}_{n}^{new} .$$

Among them,

$${P}_{n , l , k}^{r}$$

is a power allocation result for

$${t}_{n , l , k}^{r} and {P}_{n , l , k}^{i}$$

is a power allocation result for

$${t}_{n , l , k}^{i} .$$

The design of the receive-end amplitude operation function adheres to the principle of parameter simplicity. Therefore, an amplitude scaling parameter α is introduced. In this case, ƒᵣ(⋅) can be expressed as:

$${y}_{l , k}^{new} = α {y}_{l , k}^{c} .$$

FIG. 4 is an element expansion table of complex matrix variables according to examples of the present disclosure.

In block S208, the fifth semantic signals may be optimized with an objective of minimizing differences between the third semantic signals and the fifth semantic signals to obtain optimized fifth semantic signals.

In example of the present disclosure, in this block S208, the transmitter-side signal processing function and the receiver-side signal processing function may be optimized at first with the objective of minimizing the differences between the third semantic signals and the fifth semantic signals. Further, the fifth semantic signals may be adjusted based on the optimized transmitter-side processing function and the optimized receiver-side processing function to minimize the differences between the third semantic signals and the fifth semantic signals to obtain the optimized fifth semantic signals.

Specifically, the trained decoder

$${ϕ}_{D}^{*}$$

can perform an information reconstruction on the signals Y to minimize the differences between the reconstructed information \hat{M} and the original information M. Therefore, the smaller the differences between the signals Y^{new} and the signals Y are, the higher the quality of information reconstruction is after passing through the channel with a type of C_{b}.

The design principle of the transmit-end signal processing function ƒₜ(⋅) and the receive-end signal processing function ƒᵣ(⋅) is to minimize the differences between the signals Y^{new} and the signals Y based on channel feedback information while satisfying the communication constraints [symbol] , which may be expressed as:

$${min}_{{f}_{t} , {f}_{r}} {‖ {Y}^{new} - Y ‖}_{2}^{2} , s . t . 𝒞 .$$

Taking the NOMA system as an example, the channel transfer power optimization problem can be determined based on the multi-subcarrier power allocation function, the signal amplitude operation function, and the objective of minimizing the differences between the third semantic signals and the fifth semantic signals. Further, a semantic similarity-based dual transformation may be performed on the channel transfer power optimization problem to obtain a channel transfer power optimization model. Moreover, an analytical solution of the channel transfer power optimization model may be determined using Lagrange dual method. Finally, a transmitter-side subcarrier power allocation result and receiver-side amplitude scaling parameters may be obtained based on the analytical solution and predefined power constraints.

In some examples, the channel transfer power optimization problem can be refined through modeling according to the complex matrix variable element expansion table.

$${min}_{{P}_{n , l , k}^{r} , {P}_{n , l , k}^{i} , α} {d}_{1} \\ s . t . {𝒞}_{1} : \frac{1}{K} {\sum }_{k = 1}^{K} {t}_{n , l , k}^{r} {P}_{n , l , k}^{r} + {t}_{n , l , k}^{i} {P}_{n , l , k}^{{i}^{2}} \leq {P}_{n} \\ ∀ n ∈ 𝒩 , ∀ l ∈ ℒ \\ {d}_{1} = {\sum }_{l = 1}^{L} {\sum }_{k = 1}^{K} {\vert {y}_{l , k}^{new} - {y}_{l , k} \vert}^{2} = {\sum }_{l = 1}^{L} {\sum }_{k = 1}^{K} ζ {y}_{l , k}^{cr} - {y}_{l , k}^{{r}^{2}} + α {y}_{lk}^{ci} - {y}_{l , k}^{{i}^{2}} \qquad ( P1 )$$

Then, based on the meaning of the optimization problem (P1), a semantically similar dual transformation of the problem may be performed to obtain a new problem (P2) that approximates the original problem.

$${min}_{{P}_{n , l , k}^{r} , {P}_{n , l , k}^{i} , α} {P}_{sum} = {\sum }_{n = 1}^{N} {β}_{n} {\sum }_{l = 1}^{L} {\sum }_{k = 1}^{K} {t}_{n , l , k}^{r} {P}_{n , l , k}^{{r}^{2}} + {t}_{n , l , k}^{i} {P}_{n , l , k}^{{i}^{2}} \\ s . t . {𝒞}_{2} : α {\dot{y}}_{l , k}^{cr} - {\dot{y}}_{l , k}^{{r}^{2}} = 0 , ∀ k ∈ 𝒦 , ∀ l ∈ ℒ \\ {𝒞}_{3} : α {\dot{y}}_{l , k}^{ci} - {\dot{y}}_{l , k}^{{i}^{2}} = 0 , ∀ k ∈ 𝒦 , ∀ l ∈ ℒ \qquad ( P2 )$$

Among them, \dot{y} is a corresponding noiseless term of y, such

$${y}_{l , k}^{cr} = {\dot{y}}_{l , k}^{cr} + {w}_{l , k}^{newr} .$$

Problem (P2) is a weighted sum power minimization problem. The weighting coefficient βₙ is a ratio factor that balances the transmission power of each user, defined as βₙ=1/\sqrt{Pₙ}. The purpose of constraints [symbol] ₂ and [symbol] ₃ is to ensure the approximate minimization of the objective function d₁ in problem (P1).

Finally, the analytical solution for power allocation is obtained using the Lagrange dual method. By introducing Lagrange multipliers λ_{l,k} and μ_{l,k} for constraints [symbol] ₂ and [symbol] ₃, and solving the partial derivatives of the variables set to zero, the analytical solution expression for power allocation is obtained as follows:

$${P}_{n , l , k}^{r} = - \frac{α ( {λ}_{l , k} {h}_{n , l , k}^{r} + {μ}_{l , k} {h}_{n , l , k}^{i} )}{2 {β}_{n} {t}_{n , l , k}^{r}} \\ {P}_{n , l , k}^{i} = - \frac{α ( {λ}_{l , k} {h}_{n , l , k}^{i} + {μ}_{l , k} {h}_{n , l , k}^{r} )}{2 {β}_{n} {t}_{n , l , k}^{i}} \\ {λ}_{l , k} = \frac{- 2 {\sum }_{n = 1}^{N} {t}_{n , l , k}^{r}}{{α}^{2} {\sum }_{n = 1}^{N} \frac{{h}_{n , l , k}^{{2}^{}} + {h}_{n , l , k}^{{i}^{2}}}{{β}_{n}}} \\ {μ}_{l , k} = \frac{- 2 {\sum }_{n = 1}^{N} {t}_{n , l , k}^{i}}{{α}^{2} {\sum }_{n = 1}^{N} \frac{{h}_{n , l , k}^{{2}^{}} + {h}_{n , l , k}^{{i}^{2}}}{{β}_{n}}}$$

Based on the power allocation analytical solution and power constraints, calculate the amplitude scaling parameter α_{l,k} under each subcarrier power constraint. The expression is:

$${α}_{n , l} = \sqrt{{\sum }_{k = 1}^{K} \frac{{h}_{n , l , k}^{{r}^{2}} + {h}_{n , l , k}^{{i}^{2}} ( {( {\sum }_{n = 1}^{N} {t}_{n , l , k}^{r} )}^{2} + {( {\sum }_{n = 1}^{N} {t}_{n , l , k}^{i} )}^{2} )}{{KP}_{n} {{β}_{n}^{2} ( {\sum }_{n = 1}^{N} \frac{{h}_{n , l , k}^{{r}^{2}} + {h}_{n , l , k}^{{i}^{2}}}{{β}_{n}} )}^{2}}}$$

Then a maximum value may be taken to satisfy the power constraints of all subcarriers. In this way, the amplitude scaling parameter α=max{α_{1,1}, . . . , α_{n,l}, . . . , μ_{N,L}} that ensures optimal semantic communication performance may be obtained. Based on the transmitter subcarrier power allocation results

$${P}_{n , l , k}^{r} and {P}_{n , l , k}^{i} ,$$

as well as the receiver amplitude scaling parameter α, the optimized Y^{new} can be obtained.

In block S209, the optimized fifth semantic signals may be input into a pre-trained semantic decoder for semantic decoding to obtain a first decoded information and a second decoded information; where, the first decoded information may correspond semantically to the first input information, and the second decoded information may correspond semantically to the second input information.

In some examples, in this block S209, the optimized fifth semantic signals may be input into the pre-trained semantic decoder to extract semantic features specific to the first semantic signals and semantic features specific to the second semantic signals. Further, a semantic recovery and an information reconstruction may be performed based on the semantic features specific to the first semantic signals and the semantic features specific to the second semantic signals to obtain the first decoded information and the second decoded information.

As can be seen from the above, in the method disclosed, first input information and second input information from a transmitter may be obtained at first. Then, the first input information may be input into a pre-trained semantic encoder for extracting semantic features of the first input information to obtain first semantic signals and the second input information may also be input into the pre-trained semantic encoder for extracting semantic features of the second input information to obtain second semantic signals. Later, the first semantic signals and the second semantic signals may be transmitted to a first channel which performs a first signal superposition to obtain third semantic signals.

Moreover, a transmitter-side signal processing may be performed on the first semantic signals and the second semantic signals based on pre-determined channel coefficients of a second channel to obtain first processed semantic signals and second processed semantic signals. The first processed semantic signals and the second processed semantic signals may be transmitted to the second channel which performs a second signal superposition to obtain fourth semantic signals. Then, a receiver-side signal processing may be performed on the fourth semantic signals based on the channel coefficients to obtain fifth semantic signals. Further, the fifth semantic signals may be optimized with an objective of minimizing differences between the third semantic signals and the fifth semantic signals to obtain optimized fifth semantic signals. Finally, the optimized fifth semantic signals may be input into a pre-trained semantic decoder for semantic decoding to obtain first decoded information and second decoded information. Here, the first decoded information may correspond semantically to the first input information, and the second decoded information may correspond semantically to the second input information.

It can be seen that the semantic communication method and related devices disclosed combines semantic features with channel gains, aiming to minimize the differences between original semantic signals and reconstructed semantic signals by optimizing the transmitter-side signal processing function and the receiver-side signal processing function. It may address technical challenges of adaptively adjusting semantic signals based on channel gains of different subcarriers, facilitating transmissions of extracted semantic features over multi-subcarriers with varying channel gains. Additionally, it may resolve technical issues of transferring encoders/decoders trained in additive white Gaussian noise (AWGN) channels to other fading channels, eliminating drawbacks of requiring separate encoder/decoder training for channels with different statistical characteristics or types. This solution may ensure the quality of non-orthogonal multi-user semantic communications when original encoders/decoders are applied to fading channels. Moreover, a communication efficiency may be improved.

It should be noted that the method of the present disclosure can be executed by a single device, such as a computer or server. The method of the present disclosure can also be applied in a distributed scenario, where multiple devices cooperate to complete the task. In such a distributed scenario, one of the multiple devices may execute only one or more steps of the method of the present disclosure, and these multiple devices will interact with each other to complete the method.

It should be noted that the above only describes examples of the present disclosure. In some cases, actions or steps may be executed in an order different from that in the above examples and still achieve the desired results. Additionally, the processes depicted in the drawings do not necessarily require the specific or sequential order shown to achieve the desired results. In certain embodiments, multitasking and parallel processing may also be possible or advantageous.

On the same inventive concept, examples of the present disclosure also provide a semantic communication device.

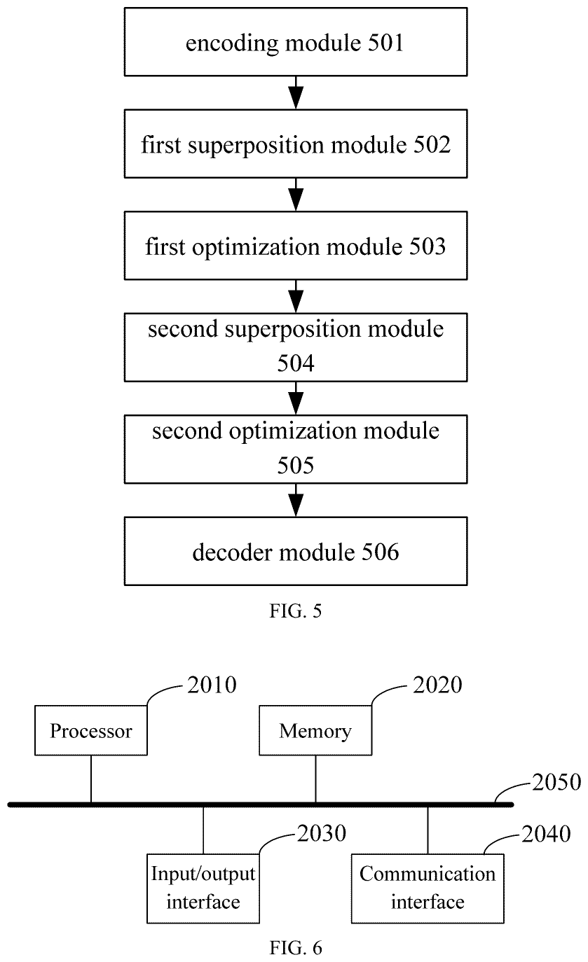

FIG. 5 is a schematic diagram illustrating a structure of a channel-transferable semantic communication device applied to a NOMA system according to examples of the present disclosure. As shown in FIG. 5, the semantic communication device may include the following modules: an encoding module 501, a first superposition module 502, a first optimization module 503, a second superposition module 504, a second optimization module 505 and a decoder module 506.

The encoding module 501 is configured to obtain first input information and second input information from a transmitter, input the first input information into a pre-trained semantic encoder for extracting semantic features of the first input information to obtain first semantic signals and input the second input information into the pre-trained semantic encoder for extracting semantic features of the second input information to obtain second semantic signals.

The first superposition module 502 is configured to transmit the first semantic signals and the second semantic signals to a first channel which performs a first signal superposition to obtain third semantic signals.

The first optimization module 503 is configured to perform a transmitter-side signal processing on the first semantic signals and the second semantic signals based on pre-determined channel coefficients of a second channel to obtain first processed semantic signals and second processed semantic signals.

The second superposition module 504 is configured to transmit the first processed semantic signals and the second processed semantic signals to the second channel which performs a second signal superposition to obtain fourth semantic signals; and perform a receiver-side signal processing on the fourth semantic signals based on the channel coefficients to obtain fifth semantic signals.

The second optimization module 505 is configured to optimize the fifth semantic signals with an objective of minimizing differences between the third semantic signals and the fifth semantic signals to obtain optimized fifth semantic signals.

The decoder module 506 is configured to input the optimized fifth semantic signals into a pre-trained semantic decoder for semantic decoding to obtain first decoded information and second decoded information; where, the first decoded information corresponds semantically to the first input information, and the second decoded information corresponds semantically to the second input information.

In some examples of the present disclosure, the encoding module 501 is further configured to convert the semantic features of the first input information into a first complex number corresponding to a subcarrier and normalize the first complex number according to a predefined power constraint to obtain the first semantic signals.

In some examples of the present disclosure, the encoding module 501 is further configured to convert the semantic features of the second input information into a second complex number corresponding to a subcarrier and normalize the second complex number according to a predefined power constraint to obtain the second semantic signals.

In some examples of the present disclosure, the first channel is an additive white Gaussian noise channel. In some examples of the present disclosure, the second channel is a Rayleigh fading channel or a Rician fading channel.

In some examples of the present disclosure, the encoding module 501 is further configured to obtain historical input messages of the transmitter as a training set; extract semantic features of the training set through an initial semantic encoder to obtain first training signals; transmit the first training signals through the first channel to the receiver; parse the first training signals through an initial semantic decoder to obtain second training signals; construct a loss function based on the first training signals and the second training signals; and train the initial semantic encoder and the initial semantic decoder by minimizing the loss function to obtain the pre-trained semantic encoder and the pre-trained semantic decoder.

In some examples of the present disclosure, the first optimization module 503 is further configured to construct a transmitter-side signal processing function based on the pre-determined channel coefficients of the second channel; obtain the first processed semantic signals based on the first semantic signals and the transmitter-side signal processing function; and obtain the second processed semantic signals based on the second semantic signals and the transmitter-side signal processing function.

In some examples of the present disclosure, the first optimization module 503 is further configured to construct a receiver-side signal processing function based on the pre-determined channel coefficients of the second channel; and obtain the fifth semantic signals based on the fourth semantic signals and the receiver-side signal processing function.

In some examples of the present disclosure, the first optimization module 503 is further configured to optimize the transmitter-side signal processing function and the receiver-side signal processing function with the objective of minimizing the differences between the third semantic signals and the fifth semantic signals; and adjust the fifth semantic signals based on the optimized transmitter-side processing function and the optimized receiver-side processing function to minimize the differences between the third semantic signals and the fifth semantic signals to obtain the optimized fifth semantic signals.

In some examples of the present disclosure, the transmitter-side signal processing function is a subcarrier power allocation function; and the receiver-side signal processing function is a signal amplitude operation function.

In some examples of the present disclosure, the first optimization module 503 is further configured to determine a channel transfer power optimization problem based on a multi-subcarrier power allocation function, a signal amplitude operation function, and the objective of minimizing the differences between the third semantic signals and the fifth semantic signals; perform a semantic similarity-based dual transformation on the channel transfer power optimization problem to obtain a channel transfer power optimization model; determine an analytical solution of the channel transfer power optimization model using Lagrange dual method; and obtain a transmitter-side subcarrier power allocation result and receiver-side amplitude scaling parameters based on the analytical solution and predefined power constraints.

In some examples of the present disclosure, the decoder module 506 is further configured to input the optimized fifth semantic signals into the pre-trained semantic decoder to extract semantic features specific to the first semantic signals and semantic features specific to the second semantic signals; and perform a semantic recovery and an information reconstruction based on the semantic features specific to the first semantic signals and the semantic features specific to the second semantic signals to obtain the first decoded information and the second decoded information.

For the sake of description, the above system is described by dividing it into various functional modules. Of course, when implementing the present application, the functions of each module may be realized in the same or multiple software and/or hardware.

The system of the above examples may be used to implement the corresponding method in any of the preceding examples and has the beneficial effects of the corresponding method, which will not be elaborated here.

On the same inventive concept, corresponding to the method of any of the foregoing examples, the present disclosure also provides an electronic device, comprising: a memory, a processor, and a computer program stored on the memory and executable by the processor, wherein the processor implements the semantic communication method described in any of the foregoing examples when executing the computer program.

FIG. 6 illustrates a more detailed hardware structure diagram of an electronic device according to this example. The device may include: a processor 2010, a memory 2020, an input/output interface 2030, a communication interface 2040, and a bus 2050. The processor 2010, memory 2020, input/output interface 2030, and communication interface 2040 are communicatively connected within the device via the bus 2050.

The processor 2010 may be implemented using a general-purpose CPU (Central Processing Unit), microprocessor, ASIC (Application-Specific Integrated Circuit), or one or more integrated circuits. It is configured to execute related programs to implement the technical solutions provided in the examples of the present specification.

The memory 2020 may be implemented using ROM (Read-Only Memory), RAM (Random Access Memory), static storage devices, or dynamic storage devices. The memory 2020 stores operating systems and other applications. When implementing the technical solutions of the examples of the present specification via software or firmware, related program codes are stored in the memory 2020 and invoked by the processor 2010 for execution.

The input/output interface 2030 is connected to an input/output module to enable information input and output. The input/output module may be integrated into the device (not shown) or externally connected to provide corresponding functions. Input devices may include keyboards, mice, touchscreens, microphones, and various sensors. Output devices may include displays, speakers, vibrators, and indicator lights.

The communication interface 2040 is connected to a communication module (not shown) to enable communication between the device and other devices. The communication module may use wired methods (e.g., USB, network cables) or wireless methods (e.g., mobile networks, Wi-Fi, Bluetooth).

The bus 2050 provides a pathway for transmitting information among components (e.g., processor 2010, memory 2020, input/output interface 2030, and communication interface 2040) of the device.

It should be noted that although the above device illustrates only the processor 2010, memory 2020, input/output interface 2030, communication interface 2040, and bus 2050, additional components necessary for normal operation may be included in practical implementations. Furthermore, those skilled in the art will understand that the device may include only components necessary for implementing the solutions of the examples of the present specification and need not include all components shown in the figure.

The electronic device in the above examples is used to implement the semantic communication method in any of the preceding examples and has the beneficial effects of the corresponding method, which are not repeated here.

Based on the same inventive concept and corresponding to any of the above method, the present disclosure further provides a non-transitory computer-readable storage medium storing computer instructions. The computer instructions are configured to cause a computer to execute the semantic communication method as described in any of the preceding examples.

The computer-readable medium in this example includes permanent and non-permanent, removable and non-removable media implemented by any method or technology for information storage. The information may be computer-readable instructions, data structures, program modules, or other data. Examples of computer storage media include, but are not limited to: phase-change memory (PRAM), static random-access memory (SRAM), dynamic random-access memory (DRAM), other types of RAM, read-only memory (ROM), electrically erasable programmable read-only memory (EEPROM), flash memory, other memory technologies, CD-ROM, DVD, other optical storage, magnetic cassettes, magnetic tape storage, other magnetic storage devices, or any other non-transitory media capable of storing information accessible to computing devices.

The storage medium in the above examples stores computer instructions for causing a computer to execute the semantic communication method as described in any of the preceding examples, with the beneficial effects of the corresponding method, which are not repeated here.

Those skilled in the art should understand that the discussion of the above examples is exemplary and not intended to imply that the scope of the present disclosure (including the claims) is limited to these examples. Under the principles of the present disclosure, the technical features in the above examples or different examples may be combined, steps may be executed in any order, and many other variations exist as described in the different aspects of the examples of the present disclosure, which are not detailed for brevity.

Additionally, to simplify explanation and discussion and to avoid obscuring the examples of the present disclosure, known power/ground connections to integrated circuit (IC) chips and other components may or may not be shown in the provided figures. Furthermore, devices may be illustrated in block diagram form to avoid obscuring the examples, considering that implementation details of such block diagrams are highly platform-dependent (i.e., these details should be fully understandable to those skilled in the art). When specific details (e.g., circuits) are provided to describe exemplary examples of the present disclosure, it will be apparent to those skilled in the art that the examples may be practiced without these details or with modifications thereto. Thus, the descriptions are to be regarded as illustrative rather than restrictive.

Although the present disclosure has been described with reference to specific examples, many alternatives, modifications, and variations will be apparent to those skilled in the art based on the foregoing description. For example, other memory architectures (e.g., dynamic RAM (DRAM)) may be used in the discussed examples.

The examples of the present disclosure are intended to cover all such alternatives, modifications, and variations falling within the broad scope of the appended claims. Therefore, any omissions, modifications, equivalent substitutions, or improvements made within the spirit and principles of the examples of the present disclosure shall be included within the scope of protection of the present disclosure.

What is claimed is:

1. A channel-transferable semantic communication method, comprising:
obtaining first input information and second input information from a transmitter;
inputting the first input information into a first pre-trained semantic encoder for extracting semantic features of the first input information to obtain first semantic signals;
inputting the second input information into a second pre-trained semantic encoder for extracting semantic features of the second input information to obtain second semantic signals;
transmitting the first semantic signals and the second semantic signals to a first channel which performs signal superposition to obtain third semantic signals;
performing a transmitter-side signal processing on the first semantic signals and the second semantic signals based on pre-determined channel coefficients of a second channel to obtain first processed semantic signals and second processed semantic signals;
transmitting the first processed semantic signals and the second processed semantic signals to the second channel which performs signal superposition to obtain fourth semantic signals;
performing a receiver-side signal processing on the fourth semantic signals based on the channel coefficients to obtain fifth semantic signals;
optimizing the fifth semantic signals with an objective of minimizing differences between the third semantic signals and the fifth semantic signals to obtain optimized fifth semantic signals; and
inputting the optimized fifth semantic signals into a pre-trained semantic decoder for semantic decoding to obtain first decoded information and second decoded information; wherein,
the first decoded information corresponds semantically to the first input information, and the second decoded information corresponds semantically to the second input information.

2. The method according to claim 1, wherein inputting the first input information into a first pre-trained semantic encoder for extracting semantic features of the first input information to obtain first semantic signals comprises:
converting the semantic features of the first input information into a first complex number corresponding to a subcarrier; and
normalizing the first complex number according to a predefined power constraint to obtain the first semantic signals.

3. The method according to claim 1, wherein inputting the second input information into a second pre-trained semantic encoder for extracting semantic features of the second input information to obtain second semantic signals comprises:
converting the semantic features of the second input information into a second complex number corresponding to a subcarrier; and
normalizing the second complex number according to a predefined power constraint to obtain the second semantic signals.

4. The method according to claim 1, wherein, the first channel is an additive white Gaussian noise channel.

5. The method according to claim 1, wherein, the second channel is a Rayleigh fading channel or a Rician fading channel.

6. The method according to claim 1, further comprising:
constructing the semantic encoder and the semantic decoder, comprising:
obtaining historical input messages of the transmitter as a training set;
extracting semantic features of the training set through an initial semantic encoder to obtain first training signals;
transmitting the first training signals through the first channel to the receiver;
parsing the first training signals through an initial semantic decoder to obtain second training signals;
constructing a loss function based on the first training signals and the second training signals; and
training the initial semantic encoder and the initial semantic decoder by minimizing the loss function to obtain the pre-trained semantic encoder and the pre-trained semantic decoder.

7. The method according to claim 2, wherein, performing a transmitter-side signal processing on the first semantic signals and the second semantic signals based on pre-determined channel coefficients of a second channel to obtain first processed semantic signals and second processed semantic signals comprises:
constructing a transmitter-side signal processing function based on the pre-determined channel coefficients of the second channel;
obtaining the first processed semantic signals based on the first semantic signals and the transmitter-side signal processing function; and
obtaining the second processed semantic signals based on the second semantic signals and the transmitter-side signal processing function.

8. The method according to claim 7, wherein, performing a receiver-side signal processing on the fourth semantic signals based on the channel coefficients to obtain fifth semantic signals comprises:
constructing a receiver-side signal processing function based on the pre-determined channel coefficients of the second channel; and
obtaining the fifth semantic signals based on the fourth semantic signals and the receiver-side signal processing function.

9. The method according to claim 8, wherein, optimizing the fifth semantic signals with an objective of minimizing differences between the third semantic signals and the fifth semantic signals to obtain optimized fifth semantic signals comprises:
optimizing the transmitter-side signal processing function and the receiver-side signal processing function with the objective of minimizing the differences between the third semantic signals and the fifth semantic signals; and
adjusting the fifth semantic signals based on the optimized transmitter-side processing function and the optimized receiver-side processing function to minimize the differences between the third semantic signals and the fifth semantic signals to obtain the optimized fifth semantic signals.

10. The method according to claim 9, wherein, the transmitter-side signal processing function is a subcarrier power allocation function; and the receiver-side signal processing function is a signal amplitude operation function; and
the method further comprises:
determining a channel transfer power optimization problem based on a multi-subcarrier power allocation function, a signal amplitude operation function, and the objective of minimizing the differences between the third semantic signals and the fifth semantic signals;
performing a semantic similarity-based dual transformation on the channel transfer power optimization problem to obtain a channel transfer power optimization model;
determining an analytical solution of the channel transfer power optimization model using Lagrange dual method; and
obtaining a transmitter-side subcarrier power allocation result and receiver-side amplitude scaling parameters based on the analytical solution and predefined power constraints.

11. The method according to claim 1, wherein, inputting the optimized fifth semantic signals into a pre-trained semantic decoder for semantic decoding to obtain a first decoded information and a second decoded information comprises:
inputting the optimized fifth semantic signals into the pre-trained semantic decoder to extract semantic features specific to the first semantic signals and semantic features specific to the second semantic signals; and
performing a semantic recovery and an information reconstruction based on the semantic features specific to the first semantic signals and the semantic features specific to the second semantic signals to obtain the first decoded information and the second decoded information.

12. An electronic device, comprising:
a memory, a processor, and a computer program stored on the memory and executable by the processor, wherein the processor executes the computer program to implement the method according to claim 1.

13. A non-transitory computer-readable storage medium, storing computer instructions, wherein the computer instructions are used to cause a computer to execute the method according to claim 1.
